(19) United States
(12) Patent Application Publication
(10) Pub. No.: US 2022/0207624 A1
(43) Pub. Date: Jun. 30, 2022

(54) ELECTRONIC PAYMENT SYSTEM, ELECTRONIC MONEY MANAGEMENT METHOD, AND NON-TRANSITORY COMPUTER READABLE MEDIUM STORING ELECTRONIC MONEY MANAGEMENT PROGRAM

(71) Applicant: NEC Platforms, Ltd., Kawasaki-shi (JP)

(72) Inventors: Hirokazu SHIGEMATSU, Kanagawa (JP); Keiji HASEGAWA, Kanagawa (JP); Yuta YAMAWAKI, Kanagawa (JP); Koichi WATANABE, Kanagawa (JP); Teruhiko TANADA, Kanagawa (JP); Masaaki HATAGAWA, Kanagawa (JP)

(73) Assignee: NEC Platforms, Ltd., Kawasaki-shi (JP)

(21) Appl. No.: 17/548,683

(22) Filed: Dec. 13, 2021

(30) Foreign Application Priority Data
Dec. 24, 2020 (JP) 2020-215051

(51) Int. Cl. G06Q 50/06; G06Q 20/40; G06Q 20/06

(52) U.S. Cl. CPC G06Q 50/06; G06Q 20/065; G06Q 20/403

(57) ABSTRACT

In an electronic payment system according to an example embodiment of the present disclosure, when a terminal device receives, from a user, an order for filling with energy a vehicle to which energy is to be supplied, it determines whether the balance of electronic money is equal to or greater than a predetermined maximum amount of money. When the balance is equal to or greater than the maximum amount of money, the terminal device causes an electronic money management server to secure the maximum amount of money as a credit amount from the balance. After energy is supplied to the vehicle on the basis of the order, the electronic money management server deducts the cost of the energy supply from the credit amount.

### INCORPORATION BY REFERENCE

This application is based upon and claims the benefit of priority from Japanese patent application No. 2020-215051, filed on Dec. 24, 2020, the disclosure of which is incorporated herein in its entirety by reference.

### BACKGROUND ART

The present disclosure relates to an electronic payment system, an electronic money management method, and a non-transitory computer readable medium storing an electronic money management program.

Electronic payment using electronic money is carried out in self-service filling station systems such as gas stations. As an example of a filling station system using electronic payment, the filling station system disclosed in Japanese Unexamined Patent Application Publication No. 2020-64551 adds more money by a preset method when there is a shortage of the amount of deposited money after fueling is done, and thereby avoids insufficient balance.

### SUMMARY

However, the filling station system disclosed in Japanese Unexamined Patent Application Publication No. 2020-64551 has a problem that, after a customer puts money to pay a fuel fee on a mobile terminal, electronic money is used for a purpose other than purchase of energy, such as the customer's purchase of another product.

In view of the above problem, an object of the present disclosure is to provide an electronic payment system, a terminal device, an electronic money management method, and a non-transitory computer readable medium storing an electronic money management program that avoid a shortage of electronic money when purchasing energy with the electronic money, and prevent the electronic money deposited to purchase energy from being used for a purpose other than purchase of energy.

An electronic payment system according to one example embodiment of the present disclosure includes a terminal device to be used by a user, and an electronic money management device configured to manage electronic money of the user, wherein the electronic money management device transmits balance information indicating balance of the electronic money of the user to the terminal device, when the terminal device receives, from the user, an order for filling with energy a vehicle to which energy is to be supplied, the terminal device determines whether the balance indicated by the balance information is equal to or greater than a predetermined maximum amount of money, when the balance is equal to or greater than the maximum amount of money, the terminal device causes the electronic money management device to secure the maximum amount of money as a credit amount from the balance, the terminal device causes an energy supply system to supply the energy to the vehicle on the basis of the order, the energy supply system being configured to supply energy to the vehicle, and after the energy is supplied to the vehicle, the electronic money management device deducts a cost of the energy supply from the credit amount.

A terminal device according to one example embodiment of the present disclosure includes a balance determination unit configured to determine whether balance of electronic money of a user is equal to or greater than a predetermined maximum amount of money when an order for filling with energy a vehicle to which energy is to be supplied is received from the user; a credit amount securing unit configured to cause an electronic money management device to secure the maximum amount of money as a credit amount from the balance when the balance is equal to or greater than the maximum amount of money, the electronic money management device being configured to manage electronic money of the user; and an order processing unit configured to cause an energy supply system to supply the energy to the vehicle on the basis of the order, the energy supply system being configured to supply energy to the vehicle.

An electronic money management method according to one example embodiment of the present disclosure includes determining, by a terminal device, whether balance of electronic money of a user of the terminal device is equal to or greater than a predetermined maximum amount of money when the terminal device receives an order for filling with energy a vehicle to which energy is to be supplied; causing, by the terminal device, an electronic money management device to secure the maximum amount of money as a credit amount from the balance when the balance is equal to or greater than the maximum amount of money, the electronic money management device being configured to manage electronic money of the user; causing, by the terminal device, an energy supply system to supply the energy to the vehicle on the basis of the order, the energy supply system being configured to supply energy to the vehicle; and deducting, by the electronic money management device, a cost of the energy supply from the credit amount after the energy is supplied to the vehicle.

An electronic money management program according to one example embodiment of the present disclosure is stored in a non-transitory computer readable medium and causes a computer to perform a step of determining whether balance of electronic money of the user is equal to or greater than a predetermined maximum amount of money when an order for filling with energy a vehicle to which energy is to be supplied is received from a user; a step of causing an electronic money management device to secure the maximum amount of money as a credit amount from the balance when the balance is equal to or greater than the maximum amount of money, the electronic money management device being configured to manage electronic money of the user; and a step of causing an energy supply system to supply the energy to the vehicle on the basis of the order, the energy supply system being configured to supply energy to the vehicle.

According to the present disclosure, there are provided an electronic payment system, a terminal device, an electronic money management method, and a non-transitory computer readable medium storing an electronic money management program that avoid a shortage of electronic money when purchasing energy with the electronic money, and prevent the electronic money deposited to purchase energy from being used for a purpose other than purchase of energy.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic view showing an example of an electronic payment system and an energy supply system according to one example embodiment of the present disclosure;

FIG. 2 is a block diagram showing the configuration of a terminal device according to one example embodiment of the present disclosure;

FIG. 3 is a block diagram showing the configuration of a relay server according to one example embodiment of the present disclosure;

FIG. 4 is a block diagram showing the configuration of an electronic money management server according to one example embodiment of the present disclosure;

FIG. 5 is a block diagram showing main elements included in the electronic payment system according to one example embodiment of the present disclosure;

FIG. 6 is a sequence chart showing an example of a process performed in the electronic payment system according to one example embodiment of the present disclosure;

FIG. 7 is a flowchart showing an example of a process performed by the terminal device according to one example embodiment of the present disclosure;

FIG. 8 is a flowchart showing an example of a process performed by the terminal device according to one example embodiment of the present disclosure;

FIG. 9 is a sequence chart showing an example of a process performed in the electronic payment system and the energy supply system according to one example embodiment of the present disclosure; and

FIG. 10 is a view showing an example of an electronic money management table.

### DESCRIPTION OF EMBODIMENTS

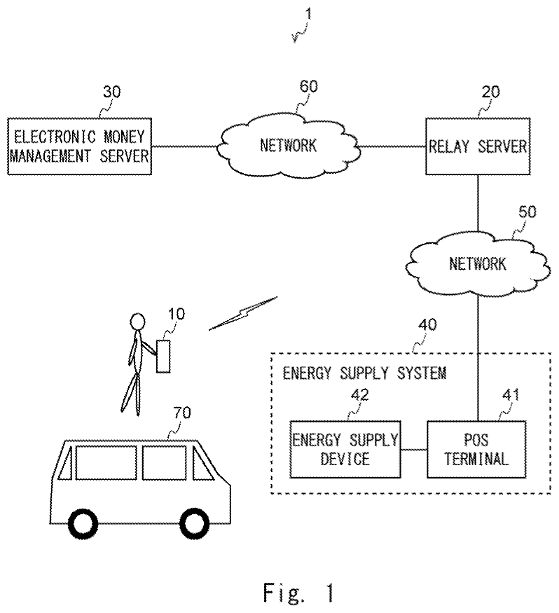

An example embodiment of the present disclosure will be described hereinafter with reference to the drawings. FIG. 1 is a schematic view showing an example of an electronic payment system 1 and an energy supply system 40 according to one example embodiment of the present disclosure.

The electronic payment system 1 is a system for making an electronic payment with electronic money, and it includes a terminal device 10, a relay server 20, and an electronic money management server 30. The terminal device 10 and the relay server 20 are able to communicate with each other through a network 50. The terminal device 10 and the electronic money management server 30 are able to communicate with each other through a network 60. The relay server 20 and the electronic money management server 30 are able to communicate with each other through the network 60. The networks 50 and 60 may include a LAN (Local Area Network) and/or a WAN (Wide Area Network). Note that the electronic payment system 1 may include a plurality of terminal devices 10.

The energy supply system 40 is a system for supplying energy to a vehicle 70 that is used by a user of the terminal device 10 (which is hereinafter referred to simply as “user”). Specific examples of the energy supply system 40 include a gas station, a plug-in station, a hydrogen station, and so on. The energy supply system 40 includes a POS (Point Of Sale) terminal 41 and an energy supply device 42. The POS terminal 41 is able to communicate with the relay server 20 through the network 50.

The POS terminal 41 controls the energy supply device 42 on the basis of order information related to energy specified by a user, and provides energy to the vehicle 70 used by the user. The order information contains information about the type and the amount of energy and information indicating purchase of energy using electronic payment. Examples of the type of energy include gasoline, light oil, electricity, hydrogen, biofuel, natural gas, and so on. Examples of the amount of energy include fill-up, a specific quantity (20 liters etc.), and so on. The vehicle 70 may be a vehicle that is driven by a user, a vehicle in which a user is riding, or the like. The vehicle 70 includes various types of vehicles such as an automobile and a motorcycle.

Further, the POS terminal 41 calculates the cost of supplied energy on the basis of the supplied amount and the current price of the energy supplied to the vehicle 70. The POS terminal 41 may be installed in a store in a gas station, a plug-in station, a hydrogen station or the like, for example.

The energy supply device 42 is a device that supplies energy to the vehicle 70. Specific examples of the energy supply device 42 include a refueling machine for supplying gasoline or light oil, a recharger for supplying electricity, and so on. Examples of energy supplied from the energy supply device 42 include gasoline, light oil, electricity, hydrogen, biofuel, and natural gas.

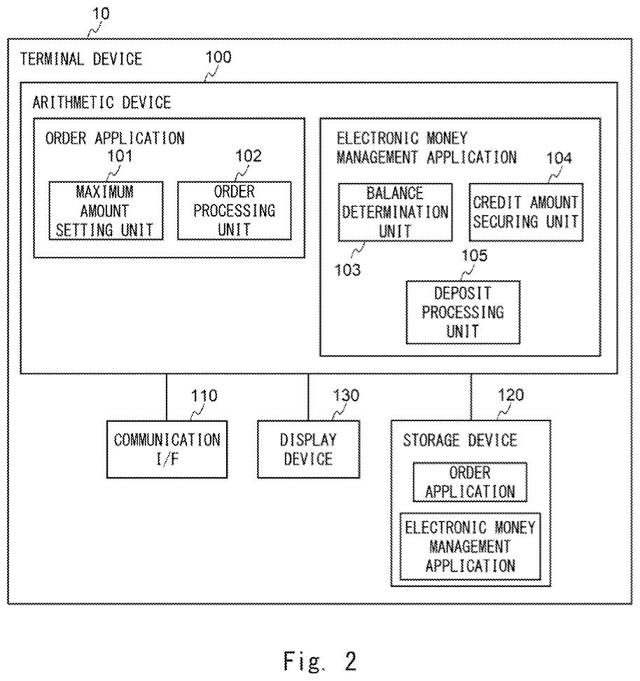

FIG. 2 is a block diagram showing the configuration of the terminal device 10. The terminal device 10 is an information processing device capable of placing an order for energy and managing electronic money. Specific examples of the terminal device 10 include a smartphone, a tablet terminal, a wearable terminal, and so on. The terminal device 10 includes an arithmetic device 100, a communication interface (I/F) 110, a storage device 120, and a display device 130.

The arithmetic device 100 is a processor such as a CPU (Central Processing Unit) or an MPU (Micro Processing Unit) that controls the device and the circuit included in the terminal device 10. The arithmetic device 100 reads and executes an application program from the storage device 120. The application program executed by the arithmetic device 100 includes an order application and an electronic money management application.

The order application is an application program for a user to purchase energy. A specific example of the order application is a fueling application by Putmenu group companies. The order application includes a maximum amount setting unit 101 and an order processing unit 102.

The maximum amount setting unit 101 is a program module for setting the maximum amount of money in accordance with an instruction from a user. The maximum amount corresponds to the amount of money that is equal to or greater than the minimum amount of money required to purchase the amount of energy that can be supplied to the vehicle 70 at a time (for example, filling up a gasoline-powered vehicle, fully charging an electric-powered vehicle etc.). The maximum amount setting unit 101 stores maximum amount information indicating the maximum amount of money specified by a user into the storage device 120.

The order processing unit 102 is a program module for processing an order related to purchase of energy. When the order processing unit 102 receives an order related to purchase of energy from a user, it stores order information indicating this order into the storage device 120. For example, the order processing unit 102 stores, into the storage device 120, the order information indicating filling the vehicle 70 with energy and the type of energy to be supplied to the vehicle 70.

In the case where a user supplies energy to the vehicle 70 in the energy supply system 40, the order processing unit 102 provides the order information stored in the storage device 120 to the energy supply system 40 through the relay server 20, so that the energy supply system 40 supplies energy to the vehicle 70 on the basis of this order information.

The electronic money management application is an application program for a user to manage their own electronic money. A specific example of the electronic money management application includes PayPay (registered trademark) or the like. The electronic money management application includes a balance determination unit 103, a credit amount securing unit 104, and a deposit processing unit 105.

The balance determination unit 103 is a program module for determining whether the balance of electronic money of a user is equal to or greater than the maximum amount specified by the user when it receives, from the user, an order for filling with energy the vehicle 70 to which energy is to be supplied.

The credit amount securing unit 104 is a program module for causing the electronic money management server 30 that manages electronic money of a user to secure the maximum amount of money as the credit amount from the balance when the balance of the user's electronic money is equal to or greater than the maximum amount.

The deposit processing unit 105 is a program module for causing the electronic money management server 30 to deposit the amount of money specified by a user to the balance of this user.

The communication interface 110 performs data communication between the terminal device 10 and the relay server 20 and the electronic money management server 30. The storage device 120 stores a program to be executed by the arithmetic device 100 and a variety of data to be processed by the arithmetic device 100. The order application and the electronic money management application are stored in the storage device 120.

The display device 130 displays various screens under control of the arithmetic device 100. The screens displayed on the display device 130 include a screen provided by the order application and a screen provided by the electronic money management application.

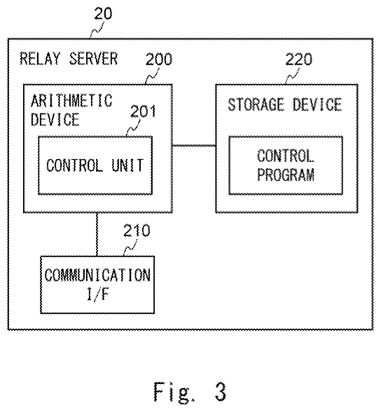

FIG. 3 is a block diagram showing the configuration of the relay server 20. The relay server 20 is an information processing device that transfers various data between the terminal device 10 and the electronic money management server 30. The relay server 20 includes an arithmetic device 200, a communication interface 210, and a storage device 220.

The arithmetic device 200 is a processor such as a CPU or an MPU that controls the device and the circuit included in the relay server 20. The arithmetic device 200 reads and executes a control program from the storage device 220. The control program includes a control unit 201, which is a program module. Note that the functions of the control unit 201 may be implemented by an integrated circuit such as an FPGA (Field-Programmable Gate Array) or an ASIC (Application Specific Integrated Circuit).

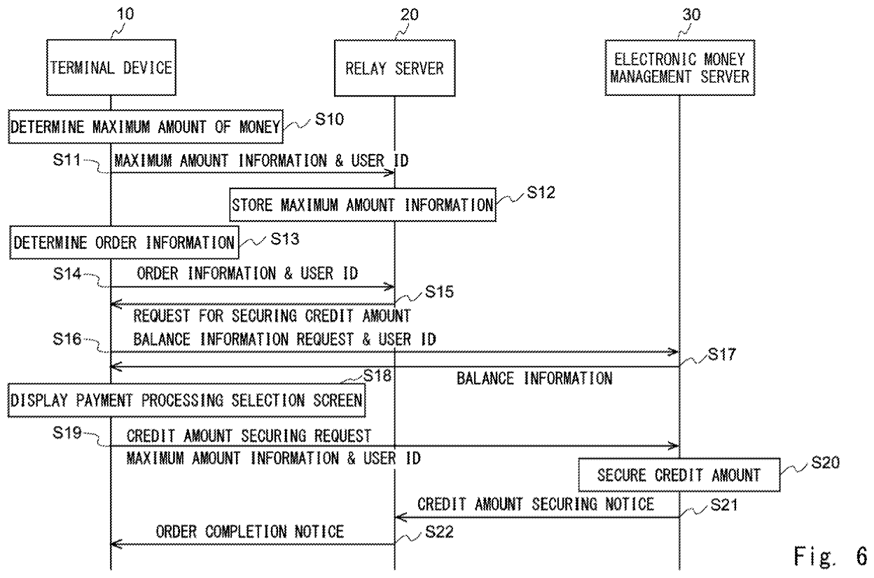

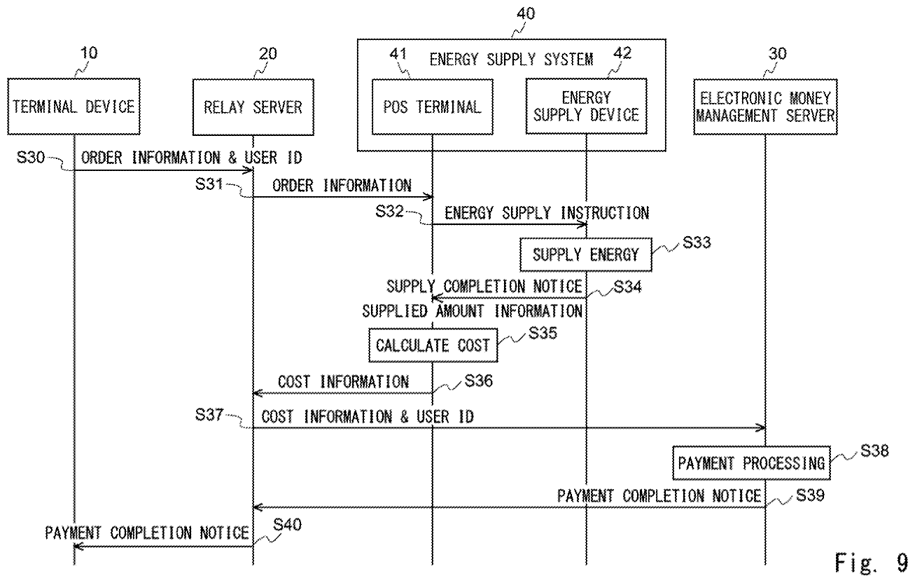

The control unit 201 is a program module for controlling the device and the circuit included in the relay server 20. The control unit 201 performs processing of the relay server 20, which will be described with reference to FIGS. 6 and 9.

The communication interface 210 performs data communication between the relay server 20 and the terminal device 10, the electronic money management server 30, and the POS terminal 41. The storage device 220 stores a program to be executed by the arithmetic device 200 and data to be processed by the arithmetic device 200. A control program is stored in the storage device 220.

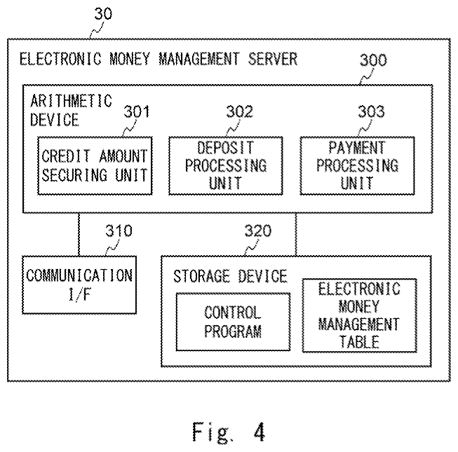

FIG. 4 is a block diagram showing the configuration of the electronic money management server 30. The electronic money management server 30 is an information processing device that manages electronic money of a user. The electronic money management server 30 corresponds to an electronic money management device. The electronic money management server 30 includes an arithmetic device 300, a communication interface 310, and a storage device 320.

The arithmetic device 300 is a processor such as a CPU or an MPU that controls the device and the circuit included in the electronic money management server 30. The arithmetic device 300 reads and executes a control program from the storage device 320. The control program includes a credit amount securing unit 301, a deposit processing unit 302, and a payment processing unit 303, which are program modules. Note that the functions of the credit amount securing unit 301, the deposit processing unit 302, and the payment processing unit 303 may be implemented by an integrated circuit such as an FPGA or an ASIC.

The credit amount securing unit 301 is a program module for securing the maximum amount of money as the credit amount from the balance when the balance of electronic money of a user is equal to or greater than the maximum amount specified by the user. The deposit processing unit 302 is a program module for performing processing of adding the amount of money specified by a user to the balance of this user. The payment processing unit 303 is a program module for performing payment processing based on product purchase of a user who is requesting payment with electronic money.

The communication interface 310 performs data communication between the electronic money management server 30 and the terminal device 10 and the relay server 20. The communication interface 310 corresponds to a receiving unit and a transmitting unit. The storage device 320 stores a program to be executed by the arithmetic device 300 and data to be processed by the arithmetic device 300. A control program and an electronic money management table are stored in the storage device 320.

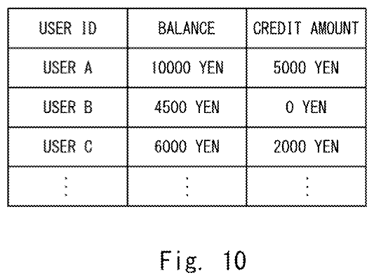

FIG. 10 is a view showing an example of the electronic money management table. The electronic money management table is a data table for managing electronic money of a user of the electronic payment system 1. In the electronic money management table, a user ID, which is identification information of a user who uses the electronic payment system 1, and the balance and the credit amount of electronic money of the user identified by this user ID are registered in association with one another. As shown in FIG. 10, the balance and the credit amount can be registered for each of a plurality of users in the electronic money management table.

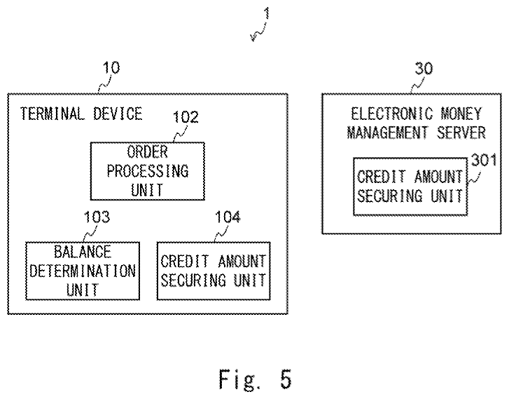

FIG. 5 is a block diagram showing main elements included in the electronic payment system 1. The electronic payment system 1 includes the terminal device 10 and the electronic money management server 30. The terminal device 10 includes the order processing unit 102, the balance determination unit 103, and the credit amount securing unit 104. The electronic money management server 30 includes the credit amount securing unit 301.

FIG. 6 is a sequence chart showing an example of a process performed in the electronic payment system 1. In Step S10, the terminal device 10 determines the maximum amount of money on the basis of an operation of specifying the maximum amount by a user, and stores maximum amount information indicating this maximum amount of money into the storage device 120. In Step S11, the terminal device 10 transmits the maximum amount information and the user ID of the user to the relay server 20. In Step S12, the relay server 20 receives the maximum amount information and the user ID from the terminal device 10, and then stores the maximum amount information in association with the user ID into the storage device 220 of the relay server 20.

In Step S13, the terminal device 10 determines order information on the basis of an operation of selecting order information by the user, and stores the order information into the storage device 120. In Step S14, the terminal device 10 transmits the order information and the user ID to the relay server 20. Processing in the case where the terminal device 10 receives an order for filling the vehicle 70 with energy is described hereinafter.

In Step S15, the relay server 20 receives the order information indicating filling the vehicle 70 with energy and the user ID from the terminal device 10, and then transmits a request for securing the credit amount to the terminal device 10. The terminal device 10 receives the request for securing the credit amount from the relay server 20, and transmits a balance information request and the user ID to the electronic money management server 30 in Step S16. The electronic money management server 30 receives the balance information request and the user ID from the terminal device 10, and then refers to the electronic money management table and transmits balance information associated with this user ID to the terminal device 10 in Step S17.

The terminal device 10 receives the balance information from the electronic money management server 30, and displays a payment processing selection screen on the display device 130 in Step S18. The payment processing selection screen is a screen that allows a user to give an instruction to secure the credit amount, deposit money, or make a cancellation. Processing in the case where the user gives an instruction to secure the credit amount is described hereinafter.

When the terminal device 10 receives an instruction to secure the credit amount from the user, the terminal device 10 transmits a credit amount securing request for requesting securing of the credit amount, the maximum amount information, and the user ID to the electronic money management server 30 in Step S19.

The electronic money management server 30 receives the credit amount securing request, the maximum amount information, and the user ID from the terminal device 10, and then refers to the electronic money management table and secures, as the credit amount, the maximum amount of money indicated by this maximum amount information from the balance of the user associated with the received user ID in Step S20. In Step S21, the electronic money management server 30 transmits a credit amount securing notice indicating that the credit amount is secured to the relay server 20. The relay server 20 receives the credit amount securing notice from the electronic money management server 30, and then transmits an order completion notice to the terminal device 10 in Step S22.

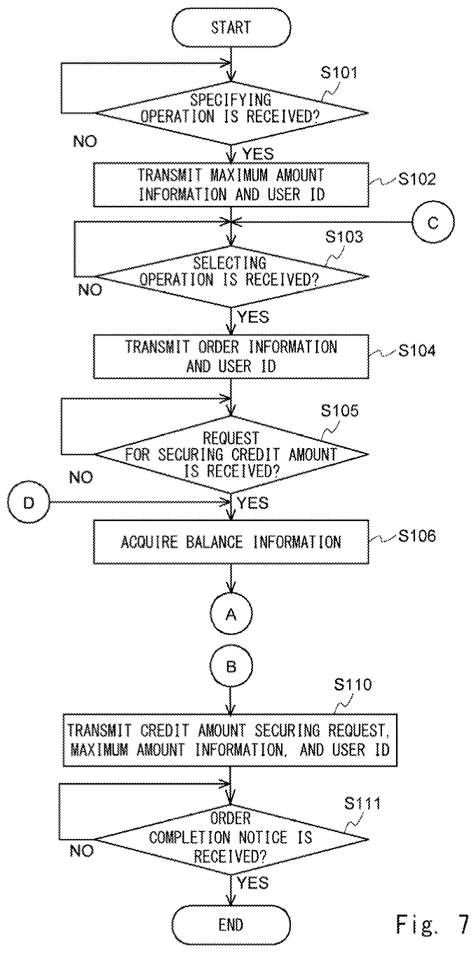

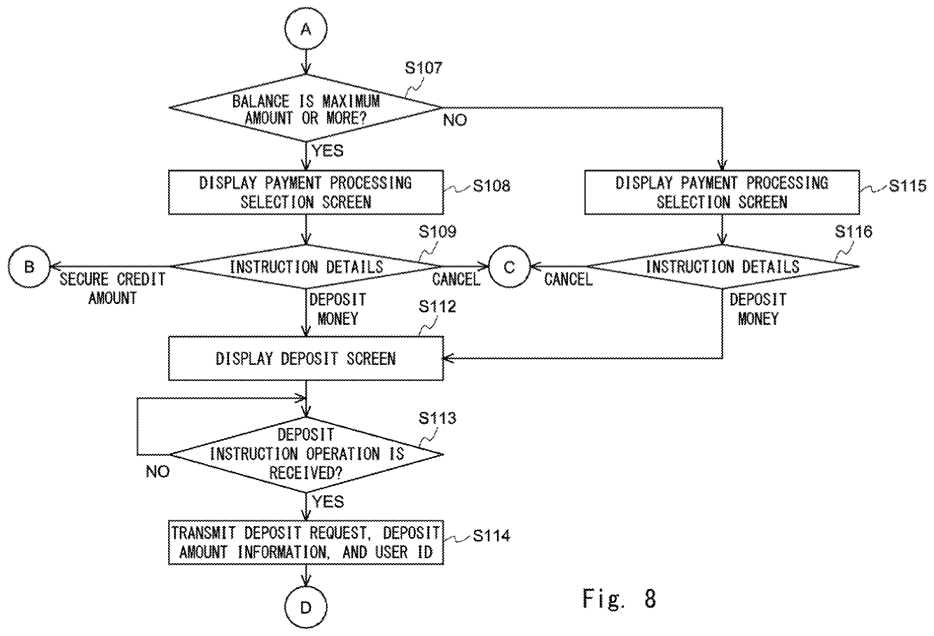

FIGS. 7 and 8 are flowcharts showing an example of a process performed in the terminal device 10. In this example embodiment, the order application performs Steps S101 to S105 and Step S111, and the electronic money management application performs Steps S106 to S110 and Steps S112 to S116.

In Step S101, the terminal device 10 determines whether a user's operation of specifying the maximum amount is received or not. When the operation of specifying the maximum amount is not received (No), the processing of Step S101 is performed again. When, on the other hand, the operation of specifying the maximum amount is received (Yes), in Step S102, the terminal device 10 transmits the maximum amount information indicating the maximum amount of money specified by the user and the user ID to the relay server 20. Note that the process may be configured to perform the processing of Steps S101 and S102 only once.

In Step S103, the terminal device 10 determines whether the user's operation of selecting order information is received or not. When the operation of selecting order information is not received (No), the processing of Step S103 is performed again. When, on the other hand, the operation of selecting order information is received (Yes), in Step S104, the terminal device 10 transmits the order information selected by the user and the user ID to the relay server 20.

In Step S105, the terminal device 10 determines whether a request for securing the credit amount is received or not from the relay server 20. When the request for securing the credit amount is not received (No), the processing of Step S105 is performed again. On the other hand, when the request for securing the credit amount is received (Yes), the process branches to Step S106.

In Step S106, the terminal device 10 transmits a balance information request and the user ID to the electronic money management server 30, and acquires the balance information of the user identified by the user ID from the electronic money management server 30. In Step S107, the terminal device 10 determines whether the balance indicated by the received balance information is equal to or greater than the maximum amount specified by the user. When the balance is equal to or greater than the maximum amount (Yes), the process branches to Step S108.

In Step S108, the terminal device 10 displays a first payment processing selection screen on the display device 130. The first payment processing selection screen is a screen that allows a user to give an instruction to secure the credit amount, deposit money, or make a cancellation.

In Step S109, the terminal device 10 determines the user's instruction details based on the first payment processing selection screen. When the user's instruction detail is an instruction to secure the credit amount, the process branches to Step S110. In Step S110, the terminal device 10 transmits the credit amount securing request, the maximum amount information, and the user ID to the electronic money management server 30. In Step S111, the terminal device 10 determines whether an order completion notice is received from the relay server 20 or not. When the order completion notice is not received (No), the processing of Step S111 is performed again. On the other hand, when the order completion notice is received (Yes), the process of FIGS. 7 and 8 ends.

In Step S109, when the user's instruction detail is an instruction to deposit money, the process branches to Step S112. Further, in Step S109, when the user's instruction detail is an instruction to make a cancellation, the process returns to Step S103.

In Step S107, when it is determined that the balance is lower than the maximum amount (No), the process branches to Step S115. In Step S115, the terminal device 10 displays a second payment processing selection screen on the display device 130. The second payment processing selection screen is a screen that allows a user to give an instruction to deposit money or make a cancellation. In Step S116, the terminal device 10 determines the user's instruction details based on the second payment processing selection screen. When the user's instruction detail is an instruction to deposit money, the process branches to Step S112. On the other hand, when the user's instruction detail is an instruction to make a cancellation, the process returns to Step S103.

In Step S112, the terminal device 10 displays a deposit screen on the display device 130. In Step S113, the terminal device 10 determines whether the user's operation of giving an instruction to deposit money is received or not. When the deposit instruction operation is not received (No), the processing of Step S113 is performed again.

When, on the other hand, the deposit instruction operation is received (Yes), in Step S114, the terminal device 10 transmits a deposit request, deposit amount information indicating the deposit amount specified by the user, and the user ID to the electronic money management server 30, and the process returns to Step S106. When the electronic money management server 30 receives the deposit request, the deposit amount information, and the user ID from the terminal device 10, the deposit processing unit 302 adds the amount of money indicated by the deposit amount information to the balance of the user identified by the user ID.

FIG. 9 is a sequence chart showing an example of a process performed in the electronic payment system 1 and the energy supply system 40. The process shown in FIG. 9 is performed when a user as a customer visits a gas station, which is an example of the energy supply system, for example.

In Step S30, the terminal device 10 transmits the order information selected by a user and the user ID of this user to the relay server 20. The relay server 20 receives the order information and the user ID from the terminal device 10, and transmits this order information to the POS terminal 41 of the energy supply system 40 in Step S31.

The POS terminal 41 receives the order information from the relay server 20, and transmits an instruction to supply energy based on this order information to the energy supply device 42 in Step S32. The energy supply device 42 receives this energy supply instruction from the POS terminal 41, and supplies energy to the vehicle 70 in Step S33.

When the energy supply to the vehicle 70 is completed, in Step S34, the energy supply device 42 transmits a supply completion notice indicating completion of energy supply to the vehicle 70 and supplied amount information indicating the amount of the energy supplied to the vehicle 70 to the POS terminal 41. The POS terminal 41 receives the supply completion notice and the supplied amount information from the energy supply device 42, and calculates the cost of the energy supplied to the vehicle 70 on the basis of the supplied amount information and the current price of the energy in Step S35. In Step S36, the POS terminal 41 transmits cost information indicating the calculated cost to the relay server 20.

The relay server 20 receives the cost information from the POS terminal 41, and transmits this cost information and the user ID of the user to the electronic money management server 30 in Step S37. The electronic money management server 30 receives the cost information and the user ID from the relay server 20, and performs payment processing on the basis of this cost information and the user ID in Step S38. To be specific, the payment processing unit 303 in the electronic money management server 30 refers to the electronic money management table and deducts the amount indicated by this cost information from the credit amount of the user identified by the received user ID.

In Step S39, the electronic money management server 30 transmits a payment completion notice indicating completion of payment to the relay server 20. The relay server 20 receives the payment completion notice from the electronic money management server 30, and transmits the payment completion notice to the terminal device 10 in Step S40.

In the above-described example embodiment, when the terminal device 10 receives, from a user, an order for filling with energy the vehicle 70 to which energy is to be supplied, it determines whether the balance of electronic money of the user is equal to or greater than a predetermined maximum amount. When the balance is equal to or greater than the maximum amount, the terminal device 10 causes the electronic money management server 30 to secure the maximum amount as the credit amount from the balance. The terminal device 10 causes the energy supply system 40 to supply energy to the vehicle 70 on the basis of the order. After the energy is supplied to the vehicle 70, the electronic money management server 30 deducts the cost of the energy supply from the credit amount.

The amount of money that is equal to or greater than the minimum amount of money required to purchase the amount of energy that can be supplied at a time to the vehicle 70 to which energy is to be supplied is thereby secured. This avoids a shortage of electronic money when purchasing energy with the electronic money and prevents the electronic money deposited to purchase energy from being used for a purpose other than the purchase of energy.

Further, in the above-described example embodiment, the electronic payment system 1 includes a plurality of terminal devices 10. Each of the plurality of terminal devices 10 sets the maximum amount of money in accordance with an instruction from each user of the plurality of terminal devices 10. The electronic payment system 1 thereby allows each user to set the maximum amount of money.

Further, in the above-described example embodiment, the terminal device 10 stores the maximum amount information indicating the maximum amount of money that is specified by a user and the order information indicating filling the vehicle 70 with energy that is received from the user. When the terminal device 10 receives an order for filling the vehicle 70 with energy again from the user, it determines whether the user's balance is equal to or greater than the maximum amount indicated by the stored maximum amount information. Then, the terminal device 10 causes the energy supply system 40 to supply energy to the vehicle 70 on the basis of the stored order information.

Since the terminal device 10 compares the balance with the maximum amount on the basis of the maximum amount of money already specified by the user, there is no need for the user to specify the maximum amount each time. Further, since the terminal device 10 causes energy to be supplied to the vehicle 70 on the basis of the order details already specified by the user, there is no need for the user to specify the order details each time. This improves user-friendliness.

Further, in the above-described example embodiment, when the credit amount is secured from the balance of the user, the terminal device 10 displays, as the balance, the amount remaining after deducting the credit amount from the balance on the display device 130. This allows the user to check the balance after the credit amount is secured.

Further, in the above-described example embodiment, when the user's balance is less than the maximum amount, the terminal device 10 displays the deposit screen for increasing the balance by deposit on the display device 130. This allows the user to be prompted to deposit money when the credit amount cannot be secured.

Further, in the above-described example embodiment, the terminal device 10 is capable of displaying the minimum amount of money required to secure the credit amount for the user on the deposit screen. This allows the user to know the minimum amount of money required to secure the credit amount.

### Other Example Embodiments

Although the maximum amount of money is specified by a user using the terminal device 10 in the above-described example embodiment, a person other than a user, such as a system administrator, for example, may set the maximum amount in another example embodiment. In this case, the relay server 20 stores the maximum amount information indicating a predetermined maximum amount of money into the storage device 220 in advance. Then, when the relay server 20 receives the order information from the terminal device 10, it provides the maximum amount information together with a request for securing the credit amount to the terminal device 10.

Further, although the relay server 20 and the electronic money management server 30 are implemented as separate devices in the above-described example embodiment, the relay server 20 and the electronic money management server 30 may be implemented in one server in another example embodiment.

Further, although a user performs an operation by referring to specified screens displayed by the order application and the electronic money management application in the above-described example embodiment, the order application and the electronic money management application may provide the content displayed on those screens to a user by voice, and the user may give a verbal instruction to those applications in another example embodiment.

The program according to an example embodiment of the present disclosure includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals. Examples of the computer include various types of information processing devices such as a PC, a server, a CPU, an MPU, an FPGA, and an ASIC.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An electronic payment system comprising:
a terminal device to be used by a user; and
an electronic money management device configured to manage electronic money of the user, wherein
the electronic money management device transmits balance information indicating a balance of the electronic money of the user to the terminal device,
when the terminal device receives, from the user, an order for filling with energy a vehicle to which energy is to be supplied, the terminal device determines whether the balance indicated by the balance information is equal to or greater than a predetermined maximum amount of money,
when the balance is equal to or greater than the maximum amount of money, the terminal device causes the electronic money management device to secure the maximum amount of money as a credit amount from the balance,
the terminal device causes an energy supply system to supply the energy to the vehicle on the basis of the order, the energy supply system being configured to supply energy to the vehicle, and
after the energy is supplied to the vehicle, the electronic money management device deducts a cost of the energy supply from the credit amount.

2. The electronic payment system according to claim 1, wherein
the electronic payment system includes a plurality of terminal devices, and
each of the plurality of terminal devices is capable of setting the maximum amount of money in accordance with an instruction from respective users of the plurality of terminal devices.

3. The electronic payment system according to claim 1, wherein
the terminal device stores maximum amount information indicating the maximum amount of money and order information received from the user and indicating the vehicle is to be filled with energy,
when the terminal device receives an order for filling the vehicle with energy again from the user, the terminal device determines whether the balance of the user is equal to or greater than the maximum amount indicated by the stored maximum amount information, and
the terminal device causes an energy supply system to supply the energy to the vehicle on the basis of the stored order information, the energy supply system being configured to supply energy to the vehicle.

4. The electronic payment system according to claim 1, wherein
the terminal device includes a display device, and
when the credit amount is secured from the balance, the terminal device displays, as the balance, on the display device, an amount remaining after deducting the credit amount from the balance.

5. The electronic payment system according to claim 1, wherein
the terminal device includes a display device, and
when the balance is less than the maximum amount, the terminal device displays, on the display device, a deposit screen for increasing the balance by deposit

6. The electronic payment system according to claim 5, wherein the terminal device displays, on the deposit screen, a minimum amount of money required to secure the credit amount.

7. The electronic payment system according to claim 1, wherein the energy includes gasoline, light oil, electricity, hydrogen, biofuel, and natural gas.

8. An electronic money management method comprising:
determining, by a terminal device, whether a balance of electronic money of a user of the terminal device is equal to or greater than a predetermined maximum amount of money when the terminal device receives an order for filling with energy a vehicle to which energy is to be supplied;
causing, by the terminal device, an electronic money management device to secure the maximum amount of money as a credit amount from the balance when the balance is equal to or greater than the maximum amount of money, the electronic money management device being configured to manage electronic money of the user;
causing, by the terminal device, an energy supply system to supply the energy to the vehicle on the basis of the order, the energy supply system being configured to supply energy to the vehicle; and
deducting, by the electronic money management device, a cost of the energy supply from the credit amount after the energy is supplied to the vehicle.

9. The electronic money management method according to claim 8, wherein the terminal device sets the maximum amount of money in accordance with an instruction from a user of the terminal device.

10. The electronic money management method according to claim 8, wherein
the terminal device stores maximum amount information indicating the maximum amount of money and order information received from the user and indicating the vehicle is to be filled with energy,
when the terminal device receives an order for filling the vehicle with energy again from the user, the terminal device determines whether the balance of the user is equal to or greater than the maximum amount indicated by the stored maximum amount information, and
the terminal device causes an energy supply system to supply the energy to the vehicle on the basis of the stored order information, the energy supply system being configured to supply energy to the vehicle.

11. The electronic money management method according to claim 8, wherein
the terminal device includes a display device, and
when the credit amount is secured from the balance, the terminal device displays, as the balance, on the display device, an amount remaining after deducting the credit amount from the balance.

12. The electronic money management method according to claim 8, wherein
the terminal device includes a display device, and
when the balance is less than the maximum amount, the terminal device displays, on the display device, a deposit screen for increasing the balance by deposit.

13. The electronic money management method according to claim 12, wherein the terminal device displays, on the deposit screen, a minimum amount of money required to secure the credit amount.

14. The electronic money management method according to claim 8, wherein the energy includes gasoline, light oil, electricity, hydrogen, biofuel, and natural gas.

15. A non-transitory computer readable medium storing an electronic money management program, the program causing a computer to perform:
determining whether balance of electronic money of the user is equal to or greater than a predetermined maximum amount of money when an order for filling with energy a vehicle to which energy is to be supplied is received from a user;
causing an electronic money management device to secure the maximum amount of money as a credit amount from the balance when the balance is equal to or greater than the maximum amount of money, the electronic money management device being configured to manage electronic money of the user; and
causing an energy supply system to supply the energy to the vehicle on the basis of the order, the energy supply system being configured to supply energy to the vehicle.

16. The non-transitory computer readable medium according to claim 15, the program causing the computer to set the maximum amount of money in accordance with an instruction from a user.

17. The non-transitory computer readable medium according to claim 15, the program causing the computer to perform:
storing maximum amount information indicating the maximum amount of money and order information received from the user and indicating the vehicle is to be filled with energy;
determining whether the balance of the user is equal to or greater than the maximum amount indicated by the stored maximum amount information when an order for filling the vehicle with energy is received again from the user; and
causing an energy supply system to supply the energy to the vehicle on the basis of the stored order information, the energy supply system being configured to supply energy to the vehicle.

18. The non-transitory computer readable medium according to claim 15, the program causing the computer to display, as the balance, on a display device, an amount remaining after deducting the credit amount from the balance when the credit amount is secured from the balance.

19. The non-transitory computer readable medium according to claim 15, the program causing the computer to display, on a display device, a deposit screen for increasing the balance by deposit when the balance is less than the maximum amount.

20. The non-transitory computer readable medium according to claim 19, the program causing the computer to display, on the deposit screen, a minimum amount of money required to secure the credit amount.
